(19) United States
(12) Patent Application Publication
(10) Pub. No.: US 2009/0243857 A1
(43) Pub. Date: Oct. 1, 2009

(54) CONTAINER WITH AN OPENING PROVIDED WITH A RECORDING MEDIUM

(75) Inventors: Hiroyuki SUNAGAWA, Ibaraki-ken (JP); Takahiro FUSHIMI, Ibaraki-ken (JP)

Correspondence Address: Studebaker & Brackett PC, 1890 Preston White Drive, Suite 105, Reston, VA, 20191, US

(73) Assignee: RISO KAGAKU CORPORATION, Tokyo (JP)

(21) Appl. No.: 12/410,952

(22) Filed: Mar. 25, 2009

(30) Foreign Application Priority Data
Mar. 26, 2008 (JP) 080636/2008

(51) Int. Cl. G08B 13/14; G03G 15/00

(52) U.S. Cl. 340/572.1; 399/8

(57) ABSTRACT

A container with an opening provided with a recording medium, which is provided for preventing reading of information on the recording medium from the time of factory shipment to the time of use, and which can be set on an external device by the user without forgetting to enable reading from the recording medium at the time of use, is inexpensively accomplished. The container with an opening provided with a recording medium, from which recorded information is able to be read, includes a seal attached to the recording medium. The seal includes a read-blocking section for blocking reading of the information recorded on the recording medium and an extending portion for sealing the opening of the container.

### BACKGROUND OF THE INVENTION

1. Field of the Invention

The present invention relates to a container with an opening provided with a recording medium for recording predetermined information.

2. Description of the Related Art

In recent years, recording media, such as RFID (Radio Frequency Identification) tags, have been used with containers with an opening used for consumable supplies, such as ink, for screen printers, for example. Such a recording medium records information such as the type and compatibility of the consumable supply contained therein.

The information recorded on the recording medium needs to be protected from unauthorized reading by a third person, in view of quality control and development of new products. Further, since each RFID tag is assigned with a unique ID, it has been pointed out recently that the activity of an individual may be identified by illegally reading, storing and analyzing the unique IDs. Therefore, it is also necessary to prevent unauthorized reading of information on the recording medium by a third person, in view of privacy protection.

U.S. Pat. No. 7,168,797 has proposed an ink container for use with screen printers. The container includes a rib formed at an upper end surface thereof, and a recording medium is attached to the rib so that the recording medium can easily be removed from the ink container after use.

Japanese Unexamined Patent Publication No. 2005-086244 has proposed a mechanism which prevents information on a recording medium from being read by covering the entire recording medium with an electromagnetic wave-blocking member, and allows the information on the recording medium to be read by exposing the recording medium out of the electromagnetic wave-blocking member.

Although the technique proposed in U.S. Pat. No. 7,168,797 can prevent unauthorized reading of information on a recording medium by a third person after the ink container is discarded or recycled if the user removes the recording medium from the container before discarding or recycling the container, it is difficult to prevent unauthorized reading of information on the recording medium by a third person from the time of factory shipment of the ink container filled with ink and sealed to the time of use when the ink container is opened.

Further, although the technique proposed in Japanese Unexamined Patent Publication No. 2005-086244 can prevent unauthorized reading of information on a recording medium by a third person from the time of factory shipment to the time of use by covering the entire recording medium with the electromagnetic wave-blocking member, the structure of the mechanism is complicated and this may result in increase in costs. Furthermore, at the time of use, the user needs to expose the recording medium out of the electromagnetic wave-blocking member with certainty. If the user forgets to do that, the recording medium which is still in the reading-disabled state may be set on an external device.

### SUMMARY OF THE INVENTION

In view of the above-described circumstances, the present invention is directed to inexpensively providing a container with an opening provided with a recording medium, which can be prevented from unauthorized reading of information on the recording medium by a third person from the time of factory shipment to the time of use, and can be set on an external device in a reading-enabled state at the time of use by the user without forgetting to enable reading from the recording medium.

In order to solve the above-described problems, a first aspect of the container according to the invention is a container with an opening provided with a recording medium from which recorded information is able to be read, the container including: a seal attached to the recording medium, the seal comprising a read-blocking section for blocking reading of the information recorded on the recording medium and an extending portion for sealing the opening of the container.

A second aspect of the container according to the invention is a container with an opening sealed with a cap and provided with a recording medium from which recorded information is able to be read, the container including: a seal attached to the recording medium, the seal comprising a read-blocking section for blocking reading of the information recorded on the recording medium and an extending portion attached to the cap sealing the opening of the container.

The “recording medium” in the first and second aspects of the container of the invention may be any recording medium as long as predetermined information recorded on the recording medium can be read with an external device. The “read-blocking section” refers to a section having a function of blocking reading, however, the read-blocking section needs not to completely block reading, and also refers to one having a function of substantially blocking reading. The “attached” refers to that the seal is attached so that reading of the recorded information on the recording medium is disabled. The “extending portion of the seal” refers to a portion that continuously extends from the read-blocking section of the seal.

The “attached to the cap” does not necessarily means that the extending portion is attached to the entire portion of the cap, and also refers to that the extending portion is attached to a part of the cap.

The recording medium of the container according to the invention may be an RFID tag having a coil-pattern antenna.

The read-blocking section of the seal of the container according to the invention may be made of a conductive material and may entirely or partially cover the coil-pattern antenna of the RFID tag.

The read-blocking section may be a coil-pattern conductor. The read-blocking section may form a short circuit between opposite end portions of the coil-pattern antenna.

The “opposite end portions of the coil-pattern antenna” refers not only to the opposite ends of the coil of the coil-pattern antenna, but also refers to portions of the coil-pattern antenna in the vicinity of the opposite ends thereof.

### BRIEF DESCRIPTION OF THE DRAWINGS

FIG. 1A is a perspective view illustrating a first embodiment of a container 1 with an opening before a seal is attached thereto,

FIG. 1B is a perspective view illustrating the first embodiment of the container 1 with the seal attached thereto,

FIG. 1C is an enlarged view illustrating main portions of the first embodiment of the container 1 with the seal attached thereto,

FIG. 2 is a schematic structural diagram of the seal 30,

FIG. 3A is a perspective view illustrating a second embodiment of the container 1 before the seal is attached thereto,

FIG. 3B is a perspective view illustrating the second embodiment of the container 1 with the seal attached thereto,

FIG. 4 is a schematic structural diagram of an RFID tag 20 fixed on a container body 10,

FIGS. 5A-5D illustrate a first embodiment of a read-blocking section 31,

FIGS. 6A-6C illustrate a second embodiment of the read-blocking section 31,

FIGS. 7A-7C illustrate a third embodiment of the read-blocking section 31,

FIG. 8A is a graph showing frequency characteristics of the RFID tag 20 in a normal state,

FIG. 8B is a graph showing frequency characteristics of the RFID tag 20 with a resonant frequency f thereof altered,

FIG. 8C is a graph showing frequency characteristics of the RFID tag 20 which does not induce a resonance phenomenon, and

FIG. 9 is a perspective view illustrating another example of the container 1 of the invention used for ink supply for inkjet printers.

### DESCRIPTION OF THE PREFERRED EMBODIMENTS

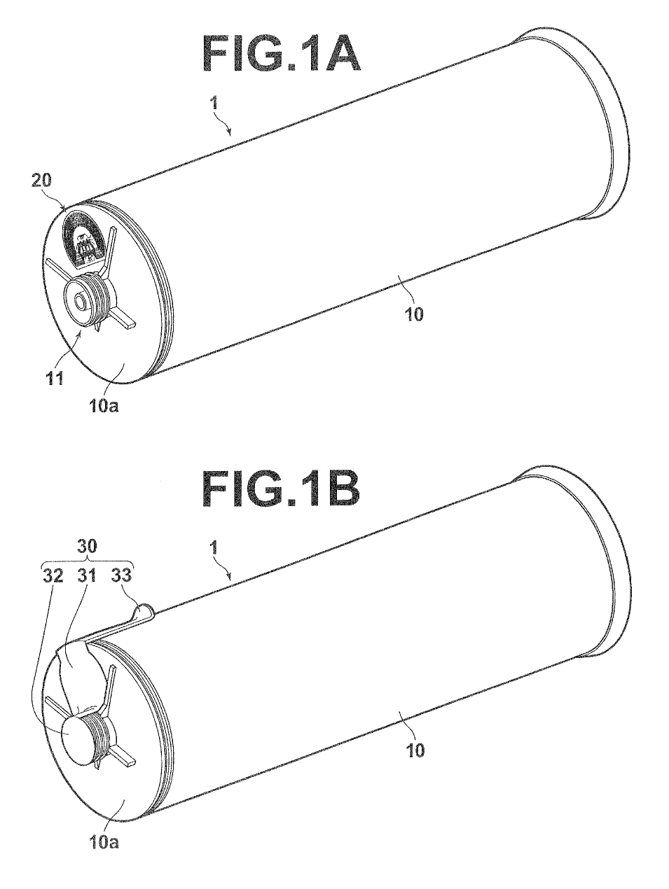

Hereinafter, a first embodiment of the container with an opening according to the present invention will be described with reference to the drawings. In this embodiment, the container is described as a container of ink supply for use with a screen printer. FIGS. 1A to 1C are perspective views showing the first embodiment of a container 1 with an opening. FIG. 1A shows the container before a seal is attached thereto, FIG. 1B shows the container with the seal attached thereto, and FIG. 1C shows enlarged view of main portions of the container with the seal attached thereto. It should be noted that, for ease of understanding, FIG. 1C shows the seal in a partially peeled state.

As shown in FIGS. 1A to 1C, the container 1 includes a cylindrical container body 10 formed of resin, a recording medium 20 and a seal 30. The container body 10 includes an opening 11 in an upper end surface 10a thereof, so that ink filled in the container body 10 is discharged through the opening 11. Further, the RFID tag 20, which is an example of the recording medium for recording predetermined information, is fixed to the upper end surface 10a with an adhesive, or the like. Furthermore, the seal 30 is attached to the container body 10 and the RFID tag 20.

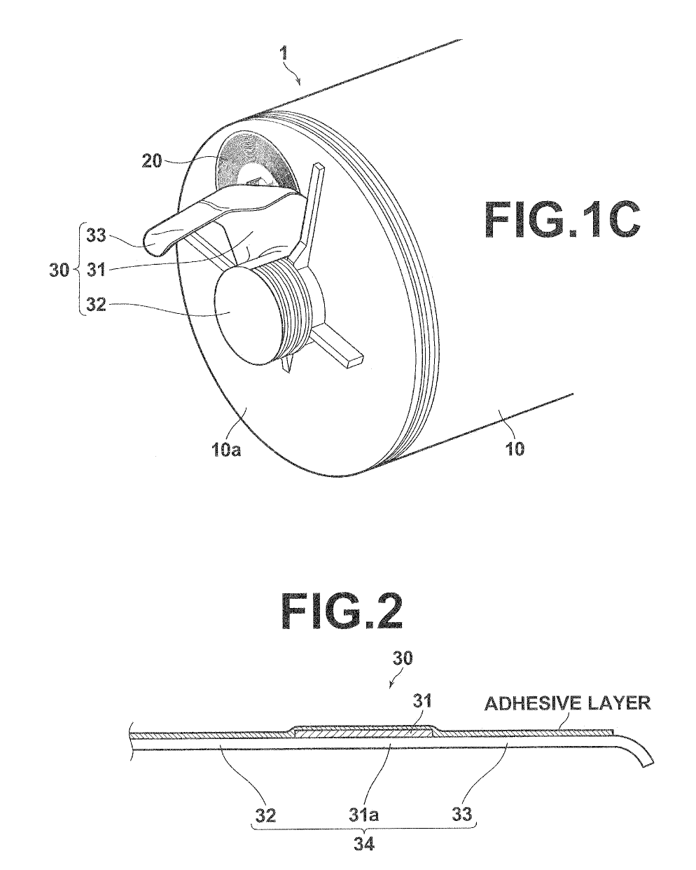

FIG. 2 shows the schematic structure of the seal 30. As shown in FIG. 2, the seal 30 includes a seal body 34, a read-blocking section 31 provided on the seal body 34, and an adhesive layer provided on the surfaces of the seal body 34 and the read-blocking section 31. The seal body 34 includes a base 31a, on which the read-blocking section 31 is provided, an extending portion 32 continuously extending from the base 31a, and a peel-off portion 33 continuously extending from the base 31a toward the opposite side from the extending portion 32. The seal 30 is attached to the RFID tag 20 such that the read-blocking section 31 covers the RFID tag 20, and the peel-off portion 33 is attached to the container body 10 with the tip portion of the peel-off portion 33 remaining free. The read-blocking section 31, the extending portion 32 and the peel-off portion 33 are peelably attached to the container body 10 and the RFID tag 20 via the adhesive layer. At the time of use, the user pulls the free tip portion of the peel-off portion 33 to peel off the seal 30 from the container body 10 in the order of the peel-off portion 33, the read-blocking section 31 and the extending portion 32, so that the opening 11 of the container 1 is expose and the container 1 is made ready for being set on the external device.

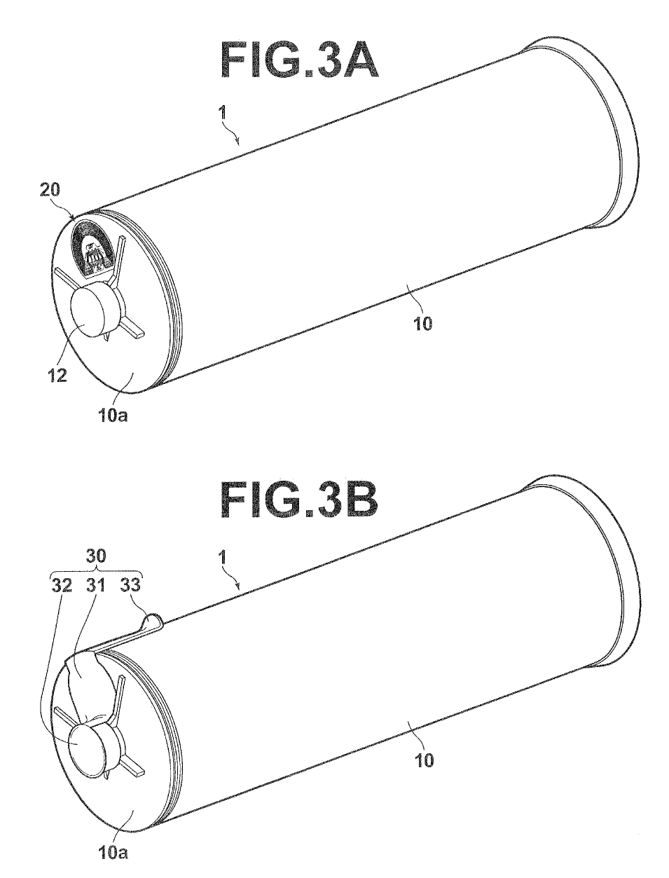

FIGS. 3A and 3B show a second embodiment of the container 1. FIG. 3A shows the container before the seal is attached thereto, and FIG. 3B shows the container with the seal attached thereto. Components shown in these drawings that are the same as those of the first embodiment are designated by the same reference numerals, and explanations thereof are omitted. In the second embodiment, the container 1 includes a cap 12, which seals the opening 11 of the container body 1. The difference between the first and second embodiments lies in that the extending portion 32 of the seal is attached to the cap 12 in the second embodiment.

In the second embodiment, the user peels off the seal 30 from the container body 10, and then opens the cap 12 to make the container 1 ready for being set on the external device at the time of use.

Next, the RFID tag 20, which is an example of the recording medium, is described in detail. It should be noted that the recording medium of the invention is not limited to the RFID tag, and includes any of other recording media that can communicate with an external device for reading the recorded information.

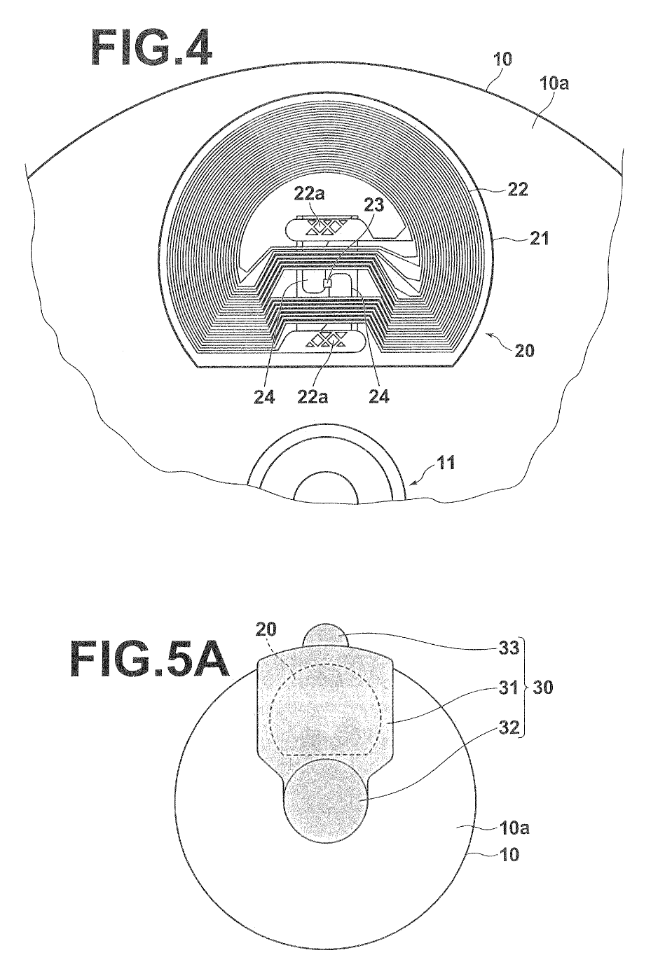

FIG. 4 shows the schematic structure of the RFID tag 20 fixed on the container body 10. As shown in FIG. 4, the RFID tag 20 includes a TAG substrate 21, which is a substantially semi-circular dielectric substrate and the shape of which is defined by a circular arc of more than 180 degrees and a chord of the circular arc, and a coil-pattern antenna 22 and an IC chip (LSI) 23 for radio communication which are disposed on the TAG substrate 21. The coil-pattern antenna 22 is formed together with a pair of electrode pads 22a formed at opposite ends of the coil-pattern antenna 22, through etching or plating of a conductor (for example, a metal conductor such as copper). The pair of electrode pads 22a includes a pair of mounting pads (not shown) for electrically connecting the IC chip 23 to the coil-pattern antenna 22. Insulating sheets 24 are attached between the mounting pads and coil-pattern antenna 22 at areas where the mounting pads and coil-pattern antenna 22 cross each other, thereby preventing short circuit.

When the RFID tag 20 is placed within a magnetic field generated by the external device, a magnetic flux passing through the coil-pattern antenna 22 induces an electromotive force and modulation is carried out, thereby achieving communication between the RFID tag 20 and the external device. A carrier wave used for modulation in this embodiment has a frequency of 13.56 MHz, however, this is not intended to limit the invention.

Next, the read-blocking section 31 is described in detail. The read-blocking section 31 covers the coil-pattern antenna 22 of the RFID tag 20 to block the radio wave, thereby disabling communication between the external device and the RFID tag 20. Specifically, in order to prevent communication between the RFID tag 20 and the external device, the RFID tag 20 is covered with the read-blocking section 31 which is formed by a material that blocks the radio wave, i.e., a conductive material such as aluminum or copper, or a material with such a metal vapor-deposited thereon. Alternatively, the base 31a of the seal body 34 may be formed by a conductive material so that the base 31a also serves as the read-blocking section 31. The read-blocking section 31 may be formed on either of the adhesive surface side or the upper surface side of the seal 30.

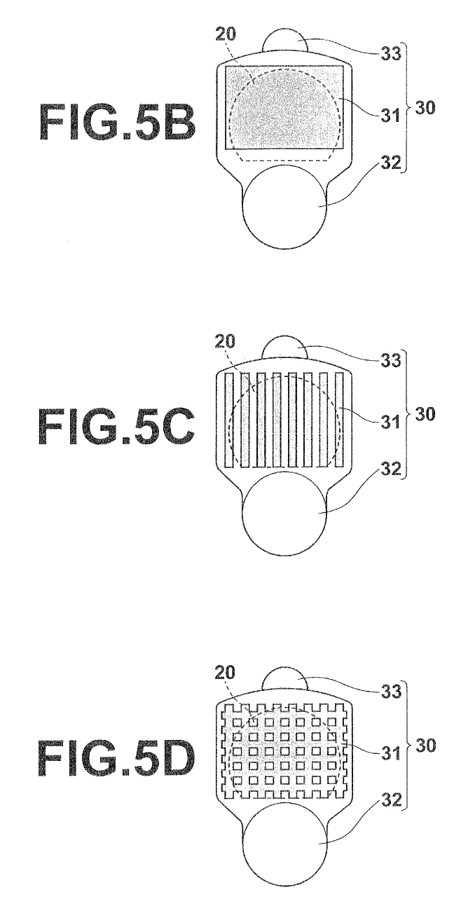

FIGS. 5A to 5D show a first embodiment of the read-blocking section 31. It should be noted that the container body 10 is omitted in FIGS. 5B to 5D. The read-blocking section 31 may be formed across the entire area of the seal 30 as shown in FIG. 5A, or may be formed partially on the seal 30 as shown in FIGS. 5B to 5D.

As shown in FIG. 5B, the read-blocking section 31 which partially covers the coil-pattern antenna 22 to partially block the radio wave can also prevent communication between the external device and the RFID tag 20. Namely, when the coil-pattern antenna 22 is partially covered, the amount of the magnetic flux from the external device passing through the coil-pattern antenna 22 is reduced, and thus generation of a predetermined electromotive force by the RFID tag 20 is prevented. The area of the coil-pattern antenna 22 that should be covered by the read-blocking section 31 varies depending on the communication power of the external device, however, in general, it may be 50 percent or more, and optionally 80 percent or more, of the total area of the coil-pattern antenna 22. The read-blocking section 31 may have a stripe structure formed by a plurality of linear conductors arranged at predetermined intervals, as shown in FIG. 5C, or may have a lattice structure formed by a plurality of linear conductors running in longitudinal and transverse directions, as shown in FIG. 5D. The structure of the read-blocking section 31 is not particularly limited as long as it can reduce the amount of the magnetic flux from the external device passing across the coil-pattern 22.

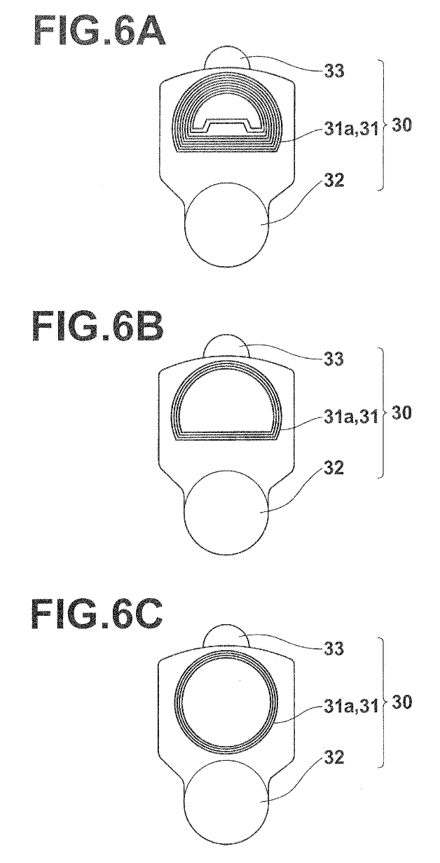

FIGS. 6A to 6C show a second embodiment of the read-blocking section 31. The read-blocking section 31 of the second embodiment is formed by a coil-pattern conductor 31a made of a conductive material provided on the seal 30. The coil-pattern conductor 31a has a resistance component (not shown). When the coil-pattern conductor 31a covers the coil-pattern antenna 22, a capacitance component of the coil-pattern antenna 22 increases and this makes a resonant frequency f of the RFID tag 20 lower than a predetermined resonant frequency, and thus communication between the RFID tag 20 and the external device can be blocked. The amount of reduction of the resonant frequency f varies depending on the communication power of the external device, however, it may be 80 percent or less, or optionally 60 percent or less, of the predetermined resonant frequency f. As shown in FIGS. 6A to 6C, the shape of the coil-pattern conductor 31a is not particularly limited as long as it can lower the resonant frequency f of the coil-pattern antenna 22. It should be noted that the resonant frequency f may not necessarily be lowered as long as it is altered from the predetermined resonant frequency, and the resonant frequency f may be raised.

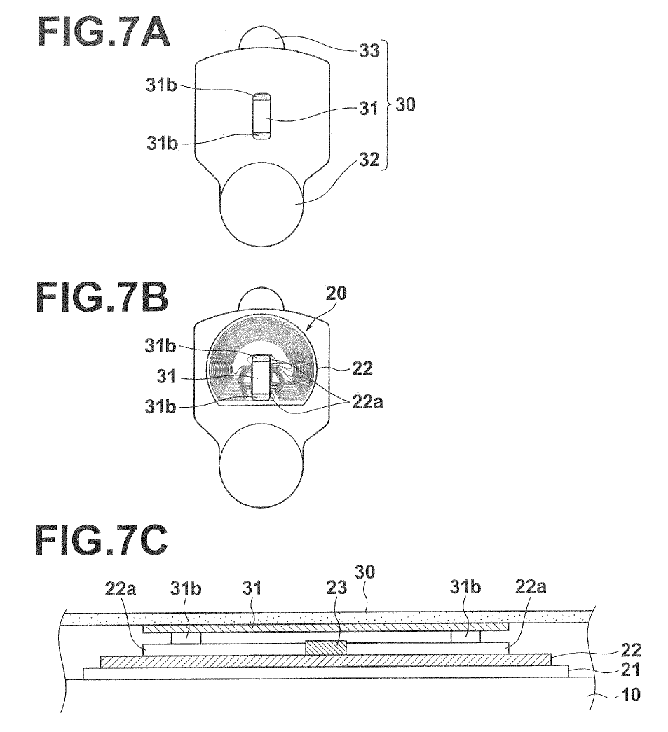

FIGS. 7A to 7C show a third embodiment of the read-blocking section 31. As shown in FIG. 7A, the read-blocking section 31 of the third embodiment includes a pair of short circuit pads 31b disposed at opposite ends of the read-blocking section 31. In the third embodiment of the read-blocking section 31, the read-blocking section 31 is formed on the adhesive surface side of the seal 30. As shown in FIGS. 7B and 7C, the short circuit pads 31b are connected to the pair of electrode pads 22a when the read-blocking section 31 is attached to the recording medium 21. In this manner, the read-blocking section 31 forms short circuit between the pair of electrode pads 22a via the pair of short circuit pads 31b. Namely, when a short circuit is formed between the opposite ends of the IC chip 23, the electromotive force is not generated, and thus communication between the external device and the RFID tag 20 can be prevented.

In the third embodiment of the read-blocking section 31, when the seal 30 is peeled off from the container body 10, the read-blocking section 31 and the short circuit pad 31b may be peeled off together with the seal 10. Alternatively, a conductive adhesive, or the like, may be applied on the surfaces of the short circuit pads 31b facing the electrode pads 22a, so that the short circuit pads 31b may be separated from the read-blocking section 31 and remain on the electrode pads 22a.

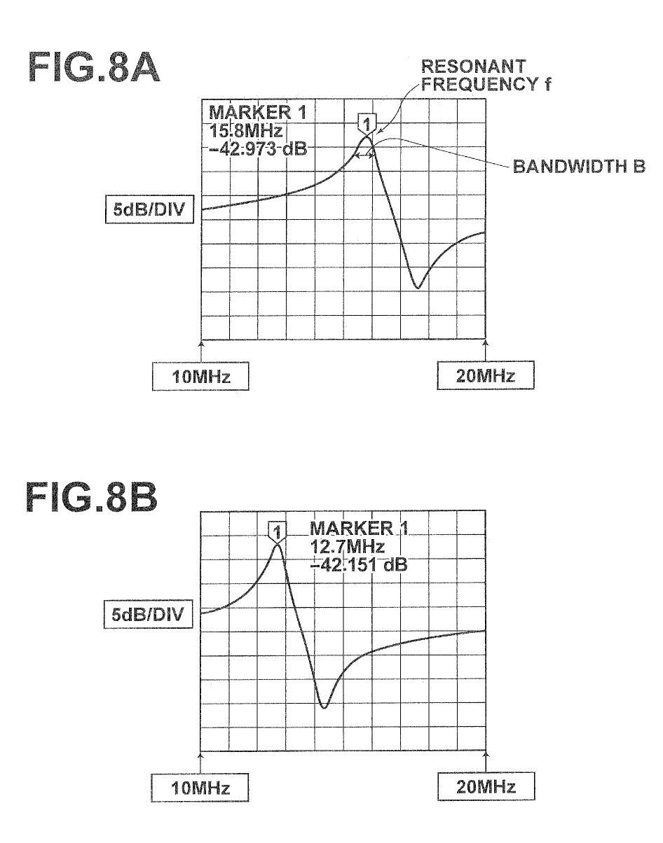

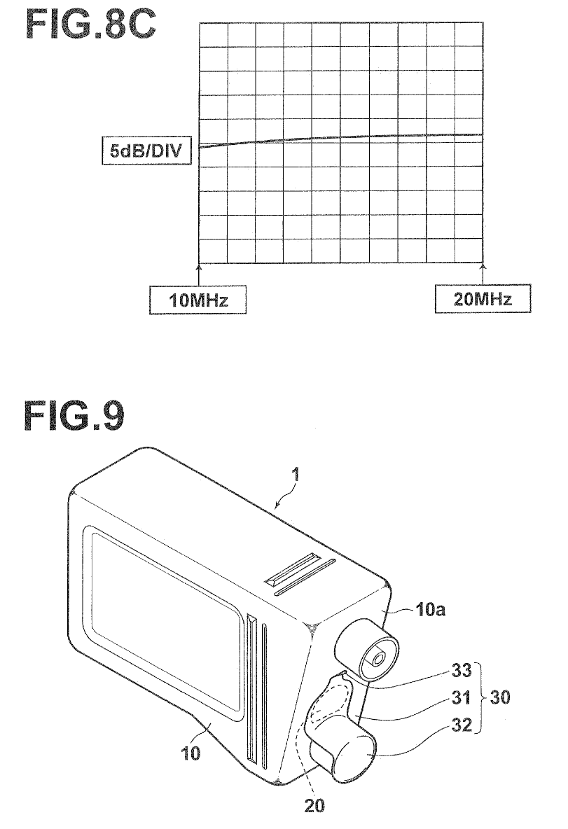

Next, operation of the invention is described. FIGS. 8A to 8C are graphs showing frequency characteristics of the RFID tag 20. FIG. 8A shows the frequency characteristics of the RFID tag 20 in a normal state, FIG. 8B shows the frequency characteristics of the RFID tag 20 with the resonant frequency f thereof altered by the read-blocking section 31, and FIG. 8C shows the frequency characteristics of the RFID tag 20 which does not induce a resonance phenomenon. In FIGS. 8A to 8C, the abscissa axis represents a measured frequency (ranging from 10 MHz to 20 MHz in this embodiment), and the ordinate axis represents a gain in 5 dB/div.

To indicate communication characteristics of the RFID tag 20, the resonant frequency f and the Q factor are used. The Q factor is used to evaluate a mountain-like shape of a locus of the measured resonant frequency f of the RFID tag 20. Namely, assuming that frequencies at which the gain is 3 dB lower than the gain at the resonant frequency f, on the left and right of the resonant frequency f in the graph, are frequencies f₁ and f₂, and the range between the frequencies f₁ and f₂ is a bandwidth B, the Q factor is calculated from a ratio between the resonant frequency f and the bandwidth B.

As shown in FIG. 8A, the resonant frequency f of the RFID tag 20 in the normal state (when the RFID tag 20 is not covered with the read-blocking section 31) is around 15.8 MHz, and the Q factor is around 23.32. As shown in FIG. 8B, the resonant frequency f of the RFID 20 with the resonant frequency f thereof altered by the read-blocking section 31 is around 12.7 MHz, and the Q factor is altered to around 26.30. As shown in FIG. 8C, the RFID tag 20 covered with the read-blocking section 31 does not induce the resonance phenomenon, and therefore the resonant frequency f is not measured.

As described above, in the first embodiment of the container 1 of the invention, the read-blocking section 31 of the seal 30 prevents unauthorized reading of information on the RFID tag 20 by a third person from the time of factory shipment to the time of use. Further, since the extending portion 32 of the seal 30 seals the opening 11, the operation of peeling off the seal 30 to open the container by the user at the time of use also enables reading of information on the RFID tag 20. Therefore, the user can set the container 1 on the external device without forgetting to enable reading from the RFID tag 20.

In the second embodiment of the invention, unauthorized reading of information on the RFID tag 20 by a third person can be prevented from the time of factory shipment to the time of use similarly to the first embodiment. Further, since the extending portion 32 of the seal 30 is attached to the cap 12, the user needs to peel off the seal 30 in order to open the container at the time of use. Therefore, the user can set the container 1 on the external device without forgetting to enable reading from the RFID tag 20.

Further, the first and second embodiments of the container 1 of the invention do not require a complicated mechanism, and therefore, costs of the container 1 are not increased.

Although the container 1 of the invention has been described as a container of ink supply for use with screen printers, this is not intended to limit the invention. As shown in FIG. 8, the container of the invention is also applicable to containers other than those of ink supply for screen printers, such as containers of ink supply for inkjet printers.

Further, the container of the invention is also applicable to containers of consumable supplies other than ink, such as containers of toner supply, or containers of consumable supplies for devices other than printers.

According to the first aspect of the container of the invention, the read-blocking section of the seal prevents unauthorized reading of information on the recording medium by a third person from the time of factory shipment to the time of use. Further, since the extending portion of the seal seals the opening, the operation of peeling off the seal to open the container by the user at the time of use also enables reading of information on the recording medium. Therefore, the user can set the container on the external device without forgetting to enable reading from the recording medium.

According to the second aspect of the invention, unauthorized reading of information on the recording medium by a third person can be prevented from the time of factory shipment to the time of use similarly to the first aspect. Further, since the extending portion of the seal is attached to the cap, the user needs to peel off the seal in order to open the container at the time of use. Therefore, the user can set the container on the external device without forgetting to enable reading from the recording medium.

Further, the first and second aspects of the container of the invention do not require a complicated mechanism, and therefore, costs of the container are not increased.

What is claimed is:

1. A container with an opening provided with a recording medium, information recorded on the recording medium being able to be read, the container comprising:
a seal attached to the recording medium, the seal comprising a read-blocking section for blocking reading of the information recorded on the recording medium and an extending portion for sealing the opening of the container.

2. A container with an opening sealed with a cap and provided with a recording medium, information recorded on the recording medium being able to be read, the container comprising:
a seal attached to the recording medium, the seal comprising a read-blocking section for blocking reading of the information recorded on the recording medium and an extending portion attached to the cap sealing the opening of the container.

3. The container as claimed in claim 1, wherein the recording medium is an RFID tag comprising a coil-pattern antenna.

4. The container as claimed in claim 2, wherein the recording medium is an RFID tag comprising a coil-pattern antenna.

5. The container as claimed in claim 1, wherein the recording medium is an RFID tag comprising a coil-pattern antenna, and the read-blocking section is made of a conductive material and entirely or partially covers the coil-pattern antenna.

6. The container as claimed in claim 2, wherein the recording medium is an RFID tag comprising a coil-pattern antenna, and the read-blocking section is made of a conductive material and entirely or partially covers the coil-pattern antenna.

7. The container as claimed in claim 1, wherein the recording medium is an RFID tag comprising a coil-pattern antenna, and the read-blocking section is a coil-pattern conductor made of a conductive material and entirely or partially covers the coil-pattern antenna.

8. The container as claimed in claim 2, wherein the recording medium is an RFID tag comprising a coil-pattern antenna, and the read-blocking section is a coil-pattern conductor made of a conductive material and entirely or partially covers the coil-pattern antenna.

9. The container as claimed in claim 1, wherein the recording medium is an RFID tag comprising a coil-pattern antenna, and the read-blocking section is made of a conductive material and forms a short circuit between opposite end portions of the coil-pattern antenna.

10. The container as claimed in claim 2, wherein the recording medium is an RFID tag comprising a coil-pattern antenna, and the read-blocking section is made of a conductive material and forms a short circuit between opposite end portions of the coil-pattern antenna.
